(19) United States
(12) Patent Application Publication
(10) Pub. No.: US 2026/0319862 A1
(43) Pub. Date: Oct. 15, 2026

(54) ADAPTIVE COMPUTE ALLOCATION DISPLAY FOR GENERATIVE RESPONSE

(71) Applicant: OpenAI OpCo, LLC., San Francisco, CA (US)

(72) Inventors: Noah Deutsch, San Francisco, CA (US); Bryant Jow, Palo Alto, CA (US); Daniel Levine, San Francisco, CA (US); Akshay Nathan, San Francisco, CA (US); Benjamin Zweig, San Francisco, CA (US)

(73) Assignee: OpenAI OpCo, LLC., San Francisco, CA (US)

(21) Appl. No.: 19/194,991

(22) Filed: Apr. 30, 2025

Related U.S. Application Data
(60) Provisional application No. 63/786,668, filed on Apr. 10, 2025.

(51) Int. Cl. G06F 9/50; G06F 9/451

(52) U.S. Cl. CPC G06F 9/5083; G06F 9/451; G06F 2209/503

(57) ABSTRACT

Systems and methods for adaptive compute allocation in generative response engines, providing a flexible and user-centric experience. A compute allocation interface allowing users to select from various settings, including default, greater, or lesser allocations, is presented. Responses based on the selected setting and estimates processing durations using a predictive model are generated. Users can adjust allocations and receive updated duration estimates. Conversation thread context and adjusts allocations for subsequent prompts may be maintained, enabling refined and efficient generation of responses.

### CROSS-REFERENCE TO RELATED APPLICATIONS

This application of and claims priority to U.S. application No. 63/786,668, filed on Apr. 10, 2025, which is expressly incorporated by reference herein in its entirety.

### BACKGROUND

Generative response engines such as large language machine-learning models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

Despite these remarkable capabilities, the computational complexity and resource allocation for these models remain a critical challenge, presenting opportunities for more nuanced and adaptive interaction paradigms that can optimize computational efficiency while maintaining high-quality output.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example system supporting a generative response engine during inference operations in accordance with some aspects of the present technology.

FIG. 2 illustrates an example graphical user interface of an artificial intelligence (AI) chat interface with a compute allocation user interface in accordance with some aspects of the present technology.

FIG. 3 illustrates an example graphical user interface of an artificial intelligence (AI) chat interface with a compute allocation user interface in accordance with some aspects of the present technology.

FIG. 4 illustrates example compute allocation user interfaces in accordance with some aspects of the present technology.

FIG. 5 illustrates an example graphical user interface of an AI assistant service with a compute allocation user interface in accordance with some aspects of the present technology.

FIG. 6 illustrates example graphical user interfaces of an AI assistant service with a compute allocation user interface in accordance with some aspects of the present technology.

FIG. 7 illustrates example graphical user interfaces with an integrated AI assistant service having a compute allocation user interface in accordance with some aspects of the present technology.

FIG. 8 illustrates an example method for adaptive compute allocation for generative response engines in accordance with some aspects of the present technology.

FIG. 9 is a block diagram illustrating an example machine learning platform for implementing various aspects of this disclosure in accordance with some aspects of the present technology.

FIG. 10A, FIG. 10B, and FIG. 10C illustrates an example transformer architecture in accordance with some aspects of the present technology.

FIG. 11 shows an example of computing system in accordance with some aspects of the present technology

### DETAILED DESCRIPTION

The rapid advancement in artificial intelligence (AI) with generative response engines, such as large language models, has transformed user interactions with digital interfaces. However, current generative response engines suffer from significant limitations in user experience and computational efficiency. Existing AI assistant services typically present users with compute allocation based on a model selected in the user interface, which fail to adapt to the nuanced complexity and urgency of different user queries. Traditional interaction paradigms of generative response engines force users into rigid communication frameworks where computational resources are uniformly allocated, regardless of the task's complexity or time sensitivity. This one-size-fits-all approach leads to inefficient user experiences, where critical tasks might receive insufficient computational attention, while simple queries consume unnecessary computational resources.

Users increasingly require generative response engines that can dynamically understand context, urgency, and complexity, adjusting computational investment accordingly. The current state of AI assistant services does not provide intuitive mechanisms for users to communicate the relative importance or depth required for different interactions, creating a fundamental mismatch between user intent and system response. These challenges highlight the need for more adaptive, context-aware generative response engines that can intelligently scale computational resources based on user requirements, communication style, and task complexity.

The present technology addresses a fundamental challenge for interactions with AI assistant services with generative response engines: the dynamic and intelligent allocation of computational resources during user interactions with generative response engines. By introducing a compute allocation user interface, the AI assistant service empowers users to have more granular control over how computational resources are applied to their specific prompts. The compute allocation user interface may provide direct manipulation of computational investment through an intuitive selector. The selector may provide users with multiple compute allocation settings, ranging from automatic allocation to explicitly defined compute levels that can be adjusted based on the specific context and urgency of the user's request.

The present technology introduces a mechanism that allows users to explicitly indicate a computational investment level that a generative response engine should use in generating a response to a prompt. The computational investment level may be associated with a distinct version of a generative response engine. While the present technology aims to eliminate the need for a user to specially choose a particular model to respond to a prompt, users can still select the optimal model for their specific needs, considering factors such as prompt complexity, urgency, and desired level of detail. By providing users with more granular control over model selection and an amount of computational investment, the AI assistant service may intelligently allocate computational resources to meet the unique requirements of each interaction, leading to improved performance and user satisfaction.

For example, a compute duration prediction model may estimate a duration for generating a response to the prompt for a default compute allocation setting. Additionally, based on the duration, the compute duration prediction model may predict a version of the generative response engine to be used to generate the response. In some cases, the version of the generative response engine may be associated with an optimal capacity of the generative response engine for generating the response based on the prompt.

In some cases, in a default compute allocation setting, the generative response engine may autonomously determine the appropriate computational resources required for a given prompt. The default compute allocation setting may leverage internal algorithms or models to assess the complexity and potential depth needed for generating a quality response.

A compute allocation user interface may further be provided to allow users to select from a range of model options and enable the system to intelligently deploy computational resources to meet the specific requirements of each interaction, leading to improved performance and user satisfaction. In some cases, the compute allocation user interface includes one or more adjustable elements such as a slider that can be adjusted to change the desired compute allocation.

For example, hen a user selects the greater compute allocation setting, the selection version of the generative response engine dedicates more computational resources to thoroughly analyze and generate the prompt. Such a setting is particularly valuable for complex queries requiring nuanced understanding, detailed analysis, or when high-accuracy outputs are critical to the user's needs. Conversely, the lesser compute allocation setting allows users to prioritize speed and immediate responsiveness over exhaustive computational analysis. This setting is ideal for quick, straightforward queries where users need rapid, concise information without extensive background processing.

The present technology addresses the problem of using a model that is too computationally intensive for simple tasks or too simplistic for complex queries. By offering users a range of model options, users can choose the best fit for their specific needs, ensuring that the system provides accurate and relevant responses within a time period of the user's choosing. By providing users with more control over computational investment, the system can optimize resource allocation, reducing waste and improving overall efficiency.

In some cases, natural language instructions or contextual cues could be used to influence model selection in addition to or in replacement of explicit interface interaction. By leveraging these indirect communication methods, users can convey complex or nuanced information about their prompt, allowing the system to make more informed decisions about model selection and computational investment.

The present technology transforms the user's interaction with generative response engines from a static, uniform experience to a dynamic but controllable dialogue where computational resources are intelligently and flexibly deployed to meet the specific requirements of each unique interaction.

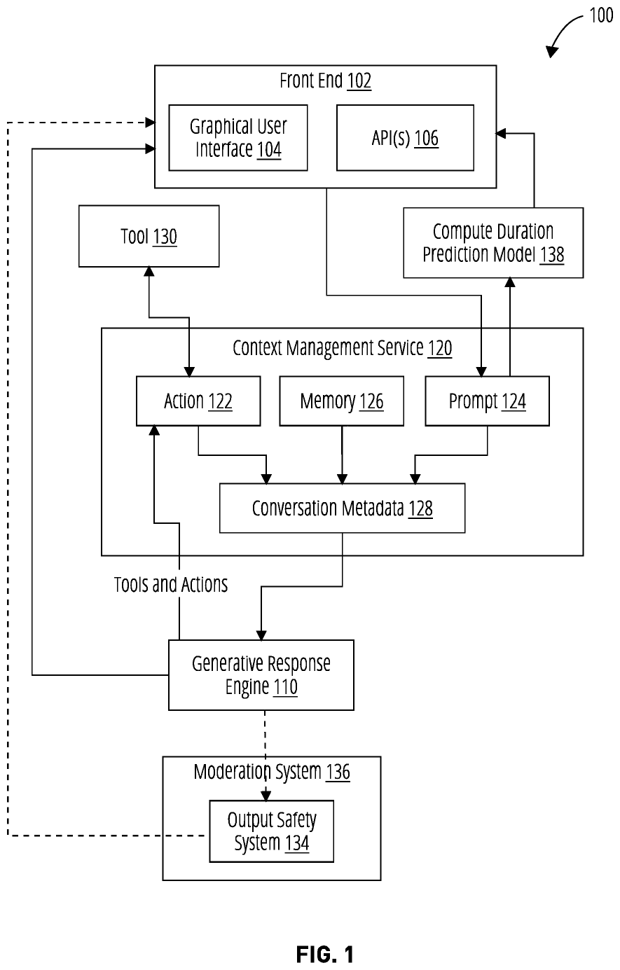

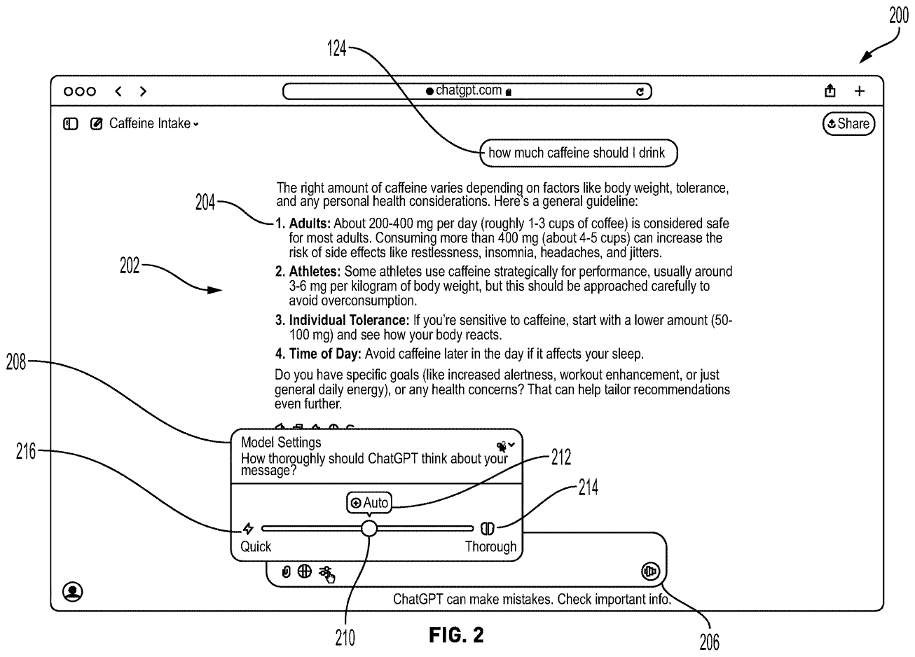

FIG. 1 illustrates an example AI assistant service supporting a generative response engine during inference operations in accordance with some aspects of the present technology. Although the example system depicts system components and an arrangement of such components, this depiction is to facilitate a discussion of the present technology and should not be considered limiting unless specified in the appended claims. For example, some components that are illustrated as separate can be combined with other components, and some components can be divided into separate components.

The generative response engine 110 is an artificial intelligence (AI) that can generate content in response to a prompt. The prompt can be from a human or a software entity (AI or applications). The prompt is generally in natural language but could be in code, including binary. Some examples of the generative response engine can include language models that generate language, such as CHATGPT, or other models, such as DALL-E, which generates images, and SORA, which generates videos. CHATGPT, DALL-E, and SORA are all provided by OPENAI, but the generative response engine is not limited to AI provided by OPENAI. The generative response engine can also be any type of generative AI and can include AI developed using various architectures such as diffusion models and transformers (e.g., autoregressive transformer architecture) and combinations of models.

In some instances, a language model, such as CHATGPT, can receive prompts to output images, video, code, applications, etc., which it can provide by interfacing with one or more other models, as will be addressed further herein.

Users and applications can interact with the generative response engine 110 through the front end 102. The front end 102 serves as the interface and intermediary between the user and the generative response engine. It encompasses the graphical user interface 104 and Application Programming Interfaces (APIs) 106 that facilitate communication, input processing, and output presentation. Generally, users interact through a graphical user interface 104 that often includes a conversational interface, and applications interact through the API 106, but this is not a requirement.

The graphical user interface 104 is the platform through which users interact with the generative response engine 110. It can be a web-based chat window, a mobile application, or any interface that supports data input and output. The graphical user interface 104 facilitates a conversation between the user and the generative response engine, as the user provides prompts in the graphical user interface 104 to which the generative response engine responds and presents those responses in the graphical user interface 104. In some aspects, graphical user interface 104 presents a conversational interface, which has attributes of a conversation thread between a user account and generative response engine 110.

The graphical user interface 104 is configured to perform input handling, context management, and output presentation. The type of inputs that can be received can be relative to the specifics of the generative response engine 110. For example, a language model is generally configured to accept text, but when the generative response engine is a multi-modal generative response engine, the front end 102 can accept voice and images/video.

In some aspects, front end 102 can be an interface to accept any input types as part of the prompt, and downstream services can determine which generative response engine or collection of generative response engines are best suited to respond to the prompt.

The graphical user interface 104 is also configured to maintain the context of the conversation, which allows for coherent and relevant responses. For example, the graphical user interface 104 is responsible for providing the conversation thread and other relevant context accessible to the front end 102 to the generative response engine along with the specific prompt to the generative response engine. In an example, a conversation between the user account and the generative response engine 110 can have taken several turns (prompt, response, prompt, response, etc.). When the user account provides a further prompt, the graphical user interface 104 can provide that prompt to the generative response engine in the context of the entire conversation.

In another example, the graphical user interface 104 may be designed to deliver a system prompt in conjunction with a user-provided prompt. A system prompt is hidden from the user account and is used to set the behavior and guidelines for the generative response engine. It can be used to define the AI's persona, style, and constraints. There can be levels of system prompts. A highest level of a system prompt might be provided by the generative response engine 110 provider and its meant to establish policies for the behavior of generative response engine 110. This highest level OS system prompt should is prohibited from being edited. A customization system prompt can be used to customize the behavior of the generative response engine and is often provided through an API call, or provided by a user account when creating a customized version of generative response engine 110. A still lower level of system prompt might include hidden information about a task. This can include chain-of-thought from a reasoning model, or context about an application the generative response engine 110 is working with to complete a task. Accordingly, the graphical user interface 104 does not always display all of the output of the generative response engine.

The graphical user interface 104 is also configured to display the responses from the generative response engine, which might include text, code snippets, images, or interactive elements.

In some aspects, the generative response engine 110 can provide instructions to the front end 102 that instruct the graphical user interface 104 about how to display some of the output from the generative response engine. For example, the generative response engine can direct the graphical user interface 104 to present code in a code-specific format, or to present interactive graphics, or static images. In other examples, the generative response engine can direct the graphical user interface 104 to present an interactive document editor where the graphical user interface 104 can be presented with the document editor so that the user account and the generative response engine can collaborate on the document.

In some aspects, the generative response engine 110 can provide instructions memory 126 to record facts in a personalization notepad, and front end 102 can be configured to notify the user account that a memory was created.

As noted above, the front end 102 can also provide one or more application programming interfaces (API(s)) 106. APIs enable developers to integrate the generative response engine's capabilities into external applications and services. They provide programmatic access to the generative response engine, allowing for customized interactions and functionalities. While APIs 106 are shown as part of a front end 102, this illustration takes the liberty of locating API 106 in front end 102 to refer to points of access to generative response engine 110 (i.e., graphical user interface 104 and APIs 106 are points of access and generative response engine 110 sends and receives messages to them in similar ways). In reality, API 106 endpoints are located at context management service 120.

The APIs 106 can accept structured requests containing prompts, context, and configuration parameters. For example, an API can be used to provide prompts and divide the prompt into system prompts and user prompts. In some aspects, the APIs 106 can provide specific inputs for which the generative response engine 110 is configured to respond with a specific behavior. For example, an API can be used to specify that it requires an output in a particular format or structured output. For example, in the chat completion API, the API call can specify parameters for the output, such as the max length for the desired output, and specify aspects of the tone of the language used in the response. Some common APIs are for participating in a conversation (Chat Completion API), for providing a single response (Completion API), for converting text into embeddings (Embeddings API), etc. The API can also be used to indicate specific decision boundaries that the generative response engine 110 might be trained to interpret. For example, the moderation API can take advantage of the AI assistant service 100's content moderation decision-making. In the case of the moderation API and others, the API might give access to services other than the generative response engine.

Some other common APIs include the Fine-Tuning API, which allows developers to customize models of the generative response engine using their own datasets; the Audio and Speech APIs, which cause the generative response engine to output speech or audio; and the Image Generation API, which causes the generative response engine to output images (which might require utilizing other models).

There can also be APIs that direct the generative response engine to interface with other applications or other generative AI engines. In such cases, the specific application or AI engine might be specified, or the generative response engine might be allowed to choose another application of AI engine to utilize in response to a prompt.

In short, the graphical user interface 104 and the APIs 106 can be used to provide prompts to the generative response engine. Prompts are sometimes differentiated into prompt types. For example, a system prompt can be a hidden prompt that sets the behavior and guidelines for the generative response engine. A user prompt is the explicit input provided by the user, which may include questions, commands, or information.

Sitting in between front end 102 and generative response engine 110 is a context management service 120. The function of context management service 120 is to manage and organize the flow of data among key subsystems, enabling the generative response engine 110 to generate responses that are contextually relevant, accurate, and enriched with additional information as required.

Action 122 facilitates auxiliary tasks that extend beyond basic text generation. In some aspects, action 122 can be actions that correspond to an API 106. In some aspects, action 122 can be agentic actions that the generative response engine 110 decides to take to carry out a user's intent as described in the prompt. For example, an action can be to call tool 130 or even another generative response engine 110.

Prompt 124 is the request or command provided by the user account through front end 102. In some aspects, prompt 124 can be further supplemented by a system prompt and other information that might be included by graphical user interface 104 or API 106 or associated with a custom generative response engine 110. In some aspects, prompt 124 can even be modified or enhanced by generative response engine 110 as addressed further below. Additionally, as the user account provides prompts and generative response engine 110 provides responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by generative response engine 110 can include a thread of user-provided messages and responses from generative response engine 110 in a multi-turn conversation. The actors in the conversation thread can be labeled so that generative response engine 110 can review the turns of the conversation. Generally, prompt 124 will include an entire conversation thread, but in some instances, prompt 124 might need to be shortened if it exceeds a maximum accepted length (generally measured by a number of tokens).

Context management service 120 can also route prompts and response through moderation system 136. In some aspects, prompts are provided to prompt safety system 134 before being provided to generative response engine 110. Prompt safety system 134 is configured to use one or more techniques to evaluate prompts to ensure a prompt is not requesting generative response engine 110 to generate moderated content. In some aspects, prompt safety system 134 can utilize text pattern matching, classifiers, and/or other AI techniques.

Since prompts can evolve over time through the course of a conversation, consisting of prompts and responses, prompts can be repeatedly evaluated at each turn in the conversation.

Memory 126 can facilitate continuity and personalization in conversations. It allows the system to maintain user-specific context, preferences, or details that may inform future interactions. A memory file can be persisted data from previous interactions or sessions that provide background information to maintain continuity. In some aspects, memory can be recorded at the instruction of generative response engine 110 when generative response engine 110 identifies a fact or data that it determines should be saved in memory because it might be useful in later conversations or sessions. In some aspects, memory 126 can also include synthesized concepts extracted from past conversation threads, and memory 126 can also encompass the ability of generative response engine 110 to search through past interactions to find relevant information to a current conversation thread.

Conversation metadata 128 can aggregate data points relevant to the conversation, including user prompt 124, action 122, and memory 126. This consolidated information package serves as the input for generative response engine 110. Conversation metadata 128 can label parts of a prompt as user provided, generative response engine provided, a system prompt, memory 126, data from action 122 or tool 130 (addressed below).

The generative response engine is the core engine that processes inputs (from context management service 120) and generates outputs. In some aspects, the generative response engine is a generative transformer, or autoregressive transformer, but it could utilize other architectures. In some examples, the transformer is multi-modal transformer that can use audio tokens (or embeddings thereof), visual tokens (or embeddings thereof), and language (or embeddings thereof) as needed.

A core feature of the generative response engine 110 is to generate content in response to prompts. The generative response engine 110 is configured to receive inputs from front end 102 that provide guidance on a desired output. The generative response engine can analyze the input and identify relevant patterns and associations in the data, and it has learned to generate a sequence of tokens that are predicted as the most likely continuation of the input. The generative response engine 110 generates responses by sampling from the probability distribution of possible tokens, guided by the patterns observed during its training. Two features of the autoregressive transformer that result in this functionality are that the autoregressive transformer might use only the decoder part of the transformer architecture and that it utilizes self-attention. By utilizing the decoder part of the transformer architecture, the transformer focuses on predicting the tokens given the previous context tokens. And the self-attention mechanism captures long-range dependencies amongst tokens, allowing it to generate contextually relevant responses (in text, audio, images, and video).

In some aspects, the generative response engine 110 can generate multiple possible responses before presenting the final one. The generative response engine 110 can generate multiple responses based on the input, and these responses are variations that the generative response engine 110 considers potentially relevant and coherent.

In some aspects, the generative response engine 110 can evaluate generated responses based on certain criteria. These criteria can include relevance to the prompt, coherence, fluency, and sometimes adherence to specific guidelines or rules, depending on the application. Based on this evaluation, the generative response engine 110 can select the most appropriate response. This selected compute allocation setting is typically the one that scores highest on the set criteria, balancing factors like relevance, informativeness, coherence, and content moderation instructions/training.

In some aspects, an instruction provided by an API 106, a system prompt, or a decision made by generative response engine 110 can cause the generative response engine 110 to interpret a prompt and re-write it or improve the prompt for a desired purpose. For example, generative response engine 110 can determine to take a prompt to make a picture and enhance the prompt to yield a better picture. In these instances, generative response engine 110 can generate its own prompts, which can be provided to a tool 130 or provided to generative response engine 110 to yield a better output response than the original prompt might have.

The generative response engine 110 can also do more than generate content in response to a prompt. In some aspects, the generative response engine 110 can utilize decision boundaries to determine the appropriate course of action based on the prompt. In some examples, a decision boundary might be used to cause the generative response engine to recognize that it is being asked to provide a response in a particular format such that it will generate its response constrained by the particular format. In some examples, a decision boundary can cause the model to refuse to generate a responsive output if the decision is that the responsive output would violate a moderation policy. In some examples, the decision boundary might cause the generative response engine to recognize that it needs to interface with another AI model or application to respond to the prompt. For example, when the generative response engine is a language model, it might recognize that it is being asked to output an image, and therefore, it needs to interface with a model that can output images to provide a response to the prompt. In another example, the prompt might request a search of the Internet before responding. The generative response engine can use a decision boundary to recognize that it should conduct a search of the Internet and use the results of that search in responding to the prompt. In another example, the prompt might request that the generative response engine take an agentic action on behalf of the user by interacting with a third-party service (e.g., book a reservation for me at . . . ), and the generative response engine can utilize a decision boundary to recognize that it needs to plan steps to locate the third-party service, contact the third-party service, and interact with the third-party service to complete the task and then report back to the user that the action has been completed.

In some cases, the prompt 124 may be sent to a compute duration prediction model 138 that is trained to provide the estimated duration for processing the prompt. In addition, the compute duration prediction model 138 may predict a version of the generative response engine 110 to be used to generate the response using the default compute allocation setting based on the estimated duration. In some cases, the version may be associated with an intended application of the generative response engine 110. For example, a response that is predicted to require minimal processing might be used to select a single-shot inference model, while a response that is predicted to require significant processing might be used to select a reasoning model.

More specifically, the compute duration prediction model 138 may be a machine learning model that predicts the compute time required for generating a response based on various input features. The input features may include user input, such as the prompt or selectable options in the user interface, and model architecture details. The compute duration prediction model 138 may use a combination of natural language processing (NLP) techniques to extract relevant features from the input text, including tokenization, embeddings, and attention mechanisms.

The underlying architecture of the compute duration prediction model 138 may be based on a deep neural network, consisting of an encoder, decoder, and output layer. The encoder may take the input text and generate a representation that captures the essential meaning and context, while the decoder may use this representation to generate a predicted compute time. During training, the compute duration prediction model 138 may be optimized using a regression-based approach, where the goal is to minimize the mean squared error (MSE) between predicted and actual compute times.

Because the compute duration prediction model 138 predicts the compute time required for generating a response based on input features, the compute duration prediction model 138 can also provide valuable insights into the computational resources needed to produce accurate and efficient responses. The optimal capacity may be predicted by the compute duration prediction model 138 by applying various scaling factors and constraints.

For example, for the following three input features: “summarize the article”, “Provide a concise summary of 200 words”, and “summarize with a larger transformer with more layers”, the compute duration prediction model 138 may predict the following compute times: Mini-Single-Pass Model: 0.5 seconds, Mini-Reasoning Model: 3.0 seconds, and Full Reasoning Model: 6.0 seconds.

Models may be generally categorized into two types: Single-Pass Models and Reasoning Models. Each type may include both standard and mini variants, where the mini models are distilled versions optimized for faster performance with reduced computational overhead. Single-Pass Models may be designed for lightweight, immediate inference tasks—such as simple summarization or quick completions—where latency is critical.

Reasoning Models, on the other hand, may support more complex, multi-step cognitive processes. They can operate in standard turn-based conversational settings or in deep research mode, where the model may leave the interactive thread to perform extended reasoning. In this mode, it can take minutes, hours, or even days to complete a task before returning with a comprehensive result. Such architecture allows the system to dynamically match model selection to the complexity and urgency of the user's request, balancing quality and efficiency.

In some cases, a scaling factor may be applied to the predicted compute times, taking into account the available resources and model architecture constraints. As such, an example resulting optimal capacities for the three input features might be: a Mini-Single Shot transformer: 256 units, a Mini-Reasoning transformer: 512 units, and a Full Reasoning transformer: 1024 units. These optimal capacities may be associated with different versions of the generative response engine 110 and may determine the default compute allocation setting. The optimal capacities may be allocated across multiple units or servers, considering factors such as hardware limitations, cooling constraints, and maintenance schedules.

In some cases, inputs corresponding to a selection may change the compute allocation from the default compute allocation setting to a greater compute allocation setting or a lesser compute allocation setting. How much more or less compute allocation is applied may be based on model architecture constraints of the selected version of the generative response engine 110. For example, continuing the example above, for a prompt “summarize this article”, the default compute allocation setting is associated with the Single-Pass Model with 256 units of computational resources. However, if the user wants more processing power, the user can adjust the default compute allocation setting in the compute allocation user interface. For example, if a selector for compute allocation is set to a greater compute allocation setting, additional units of computational resources on top of the original 256 units may be used to generate the response.

In contrast, for a prompt “provide a concise summary of 200 words”, the default compute allocation setting may be associated with the Mini-Reasoning Model with 512 units of computational resources. If the user wants to prioritize speed over resource allocation, the user can adjust the default compute allocation setting in the compute allocation user interface. For instance, if a selector for compute allocation is set to a lesser compute allocation setting, fewer units of computational resources than the original 512 units may be used to generate the response.

When generative response engine 110 determines that it should take an agentic action on behalf of the user or it should call a tool to aid in providing a quality response to the user account, the generative response engine 110 might call a tool 130 or cause an action 122 to be performed. As indicated above, tools 130 can include internet browsers, editors such as code editors, other AI tools etc. Actions 122 are actions that the generative response engine 110 can cause to be performed, perhaps using tool 130. As used herein actions 122 should be considered to cover a broad array of actions that generative response engine 110 can perform with or without tools 130. Tools 130 may encompass a broad range of services and software, including computer operating systems (which the generative response engine 110 can control on the user's behalf), robotic actuators, web browsers, and specific applications.

Additionally, the generative response engine 110 can also generate portions of responses that are not displayed to the user. For example, the generative response engine 110 can direct the front end 102 to provide specific behaviors, such as directions for how to present the response from the generative response engine 110 to the user account. In another example, the generative response engine 110 can provide response portions dictated by an API, where portions of the response to the API might be for the consumption of the calling application but not for presentation to the end user. In another example, some generative response engine 110 are reasoning models, which are generative response engine 110 that are configured to output a raw chain-of-thought before preparing a final response to a prompt. The raw chain-of-thought might not be presented to a user account or application calling an API. Instead, another generative response engine 110 might summarize the raw chain-of-thought into a more consumable and useful output for the user account or application.

While FIG. 1 shows responses being provided back to front end 102 directly, in some aspects, the responses might be returned by way of context management service 120.

FIG. 2 illustrates an example graphical user interface of an artificial intelligence (AI) assistance service with a compute allocation user interface in accordance with some aspects of the present technology.

The example graphical user interface 200, an example of graphical user interface 104, of the AI assistant service 100 includes a conversation thread 202 with a prompt 124 and a response 204. The prompt 124 may be entered in an prompt composer 206 prompt composer 206. A compute allocation user interface 208 may be presented when requested. The compute allocation user interface 208 may include a selector 210 that can be used to select a compute allocation. In some cases, there is a default compute allocation setting 212, one or more greater compute allocation setting 214, and one or more lesser compute allocation setting 2 16. In some cases, the selector 210 is a slider and the different settings are presented with the slider.

The prompt 124 that is entered into the prompt composer 206, may be provided by the front end 102 to a module (such as the compute duration prediction model 138), which may be AI or a deterministic heuristic. The front end 102 then receives, from the module, an estimated duration for the default compute allocation setting 212. In some cases, the module that determines the estimated duration for the default compute allocation setting 212 may also output other selectable response time predictions at the same time. In some cases, the module that determines estimated duration for the default compute allocation setting 212 may also select a particular model or version of a model of the generative response engine 110, unless the user specified a particular model.

Metadata associated with the estimated duration for determined default compute allocation setting 212 may be processed by the front end 102 to determine updates to the graphical user interface 104 to update the compute allocation user interface 208. The update may include changes to displayed time durations associated with the different settings, the type of selector 210 that will be displayed, and/or other types of performance indicators.

In addition, the front end 102 may also implement other visual effects to enhance the user experience. These could include animations, transitions, or other effects triggered when the user selects a new compute allocation setting or when the estimated duration changes. Furthermore, notification alerts or toast messages may be displayed to provide additional context or suggestions for the updated compute allocation settings. The graphical user interface 104 may also display system resources in real-time, such as GPU usage, memory utilization, or disk space, to help users understand the impact of their selection on system performance.

In some cases, the compute allocation user interface 208 may further include various types of selectors 210, such as gauges, dials, toggles, switches, sliders, and proportional control knobs, which allow users to intuitively adjust and fine-tune their computational resource allocations. Gauges and dials may provide a visual representation of current and target resource allocations, allowing users to quickly assess progress towards their goals. Toggles and switches may enable users to rapidly toggle between different modes or settings, such as expedited mode or detailed response mode. Sliders allow users to make gradual adjustments to their resource allocations over time, while proportional control knobs enable users to fine-tune their settings in small increments. By incorporating at least one of these different types of selectors 210, the compute allocation user interface 208 provides users with a means of controlling their computational resource utilization.

Presenting the settings in the form of a slider simplifies how users interact with the AI assistant service. A user may dynamically control the compute allocation in a one-dimensional display (a line). One side of the slider may be associated with lesser compute allocation settings 216 and the other side may be associated with greater compute allocation settings 214, with the default compute allocation setting 212 in the middle. In other cases, in addition to a single slider with multiple settings, the interface may include multiple sliders, each representing a different level of computational resource allocation. For example, users may be able to adjust two separate sliders, one for “speed” and one for “detail”, with default values set by the compute duration prediction model 138.

In some cases, the compute allocation user interface 208 may use a non-linear scale for the slider, where each increment or decrement of the slider corresponds to a different level of computational resource allocation. For example, the slider may be labeled as “Low”, “Medium”, and “High” with corresponding values of 100, 500, and 2000 units of computational resources. In some cases, the compute allocation user interface 208 may use discrete settings that users can select from, rather than a continuous scale. For example, users may be able to choose from three pre-defined settings: “Basic”, “Standard”, and “Advanced”, each corresponding to a specific level of computational resource allocation (e.g., 100 units for Basic, 500 units for Standard, and 2000 units for Advanced). These “units” may correspond to abstract compute credits, internal scheduling weights, or normalized compute metrics (e.g., a blend of token count, model size, inference time, or energy usage). For instance, a short prompt processed by a large reasoning model may require significantly more compute allocation than a longer prompt handled by a lightweight model. Using abstract compute units allows the system to account for these nuances, maintain flexibility in how tasks are mapped to resources, and offer a more intuitive experience for users without exposing low-level implementation details.

In some cases, the user's prompt may be dynamically adjusted based on the nature of the input and the selected compute allocation level. For example, if a user selects a greater compute allocation, the original prompt may be enriched to request more detailed reasoning, deeper contextual analysis, or multi-step problem solving. This ensures that the additional compute resources are put to meaningful use, unlocking the full capabilities of advanced reasoning models. Conversely, under a lesser compute allocation, the prompt may be simplified or truncated, focusing on producing a fast, efficient response that still fulfills the core user intent without invoking unnecessary computation.

Adaptive prompt handling also enables better alignment between user expectations and system behavior. Rather than expecting users to understand how to craft prompts for different levels of model complexity, the system takes on the responsibility of tailoring the request to match the available resources. This design abstracts away the need for prompt engineering expertise and helps ensure more consistent results across varying compute tiers. In effect, the system becomes smarter not just in how it answers—but in how it asks the question on the user's behalf.

In some cases, the compute allocation user interface 208 may use an analogous controller that allows users to adjust the compute allocation setting by rotating or moving a wheel-like control. For example, a cylindrical dial with incremental markings (e.g., 100, 200, 300) would allow users to select from different levels of computational resource allocation. In some cases, the compute allocation user interface 208 may use intuitive labeling for the slider and other controllers, where the labels are clearly descriptive and easy to understand. For example, a slider with labels “Fast”, “Medium”, and “Slow” would make it clear to users what level of computational resource allocation each setting corresponds to.

In some cases, the compute allocation user interface 208 may use feedback mechanisms that provide users with information about the current compute allocation setting, such as a meter or gauge that displays the amount of computational resources currently being used. This can help users monitor their usage and adjust the settings accordingly.

In some cases, the selector may be presented in a two-dimensional (such as an X-Y axis graph) or other visual interface to give users more granular control over response characteristics. For example, the user can move a selector along both dimensions (X and Y axes) to fine-tune their desired response characteristics. The X-axis might represent the compute allocation level, with options ranging from “Lesser” to “Greater”. The Y-axis might represent the desired tone or style of the response, with options such as “Formal”, “Informal”, “Creative”, or “Conversational”.

As such, users may simultaneously adjust multiple parameters like reasoning depth, creativity, specificity, or tone in a second dimension, creating a more nuanced and customizable complexities in determining the compute allocation.

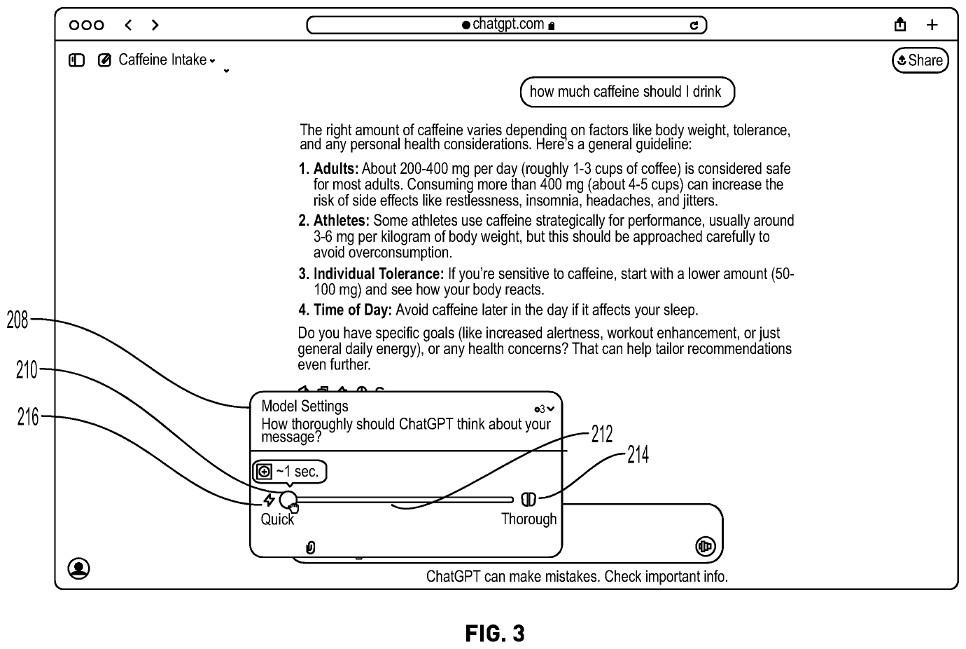

FIG. 3 illustrates an example graphical user interface 300, which is an example of graphical interface 104, of an artificial intelligence (AI) chat interface with a compute allocation user interface in accordance with some aspects of the present technology.

The example graphical user interface 300 of the AI assistant service shows the selector 210 moved to a lesser compute allocation setting 216 and a time estimate presented of ~1 sec. Similarly, the selector 210 may be moved to a greater compute allocation setting 214 and a greater time estimate may be shown.

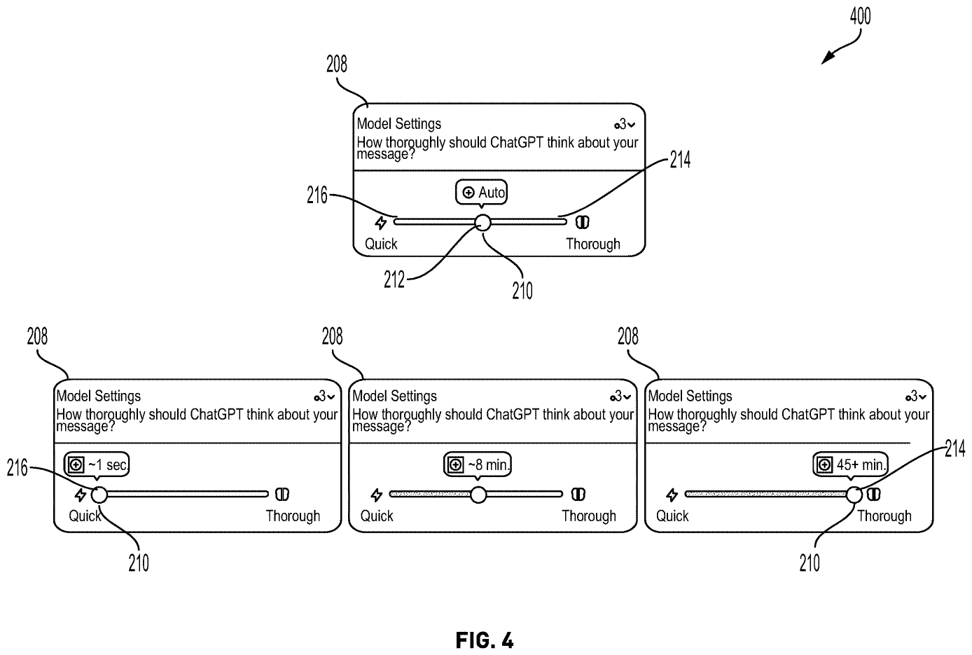

FIG. 4 illustrates example compute allocation user interfaces in accordance with some aspects of the present technology.

The example compute allocation user interfaces 400 illustrate how the selector 210, being a slider, may be moved between a lesser compute allocation setting 216, a default compute allocation setting 212, and a greater compute allocation setting 214. The different time estimates may also reflect the different compute allocations. Providing time estimates gives users a clear and intuitive understanding of how long a response will take, helping to set accurate expectations and improve the overall experience.

The example compute allocation user interfaces 400 further illustrate that in some cases the default compute allocation setting 212 may or may not show a time duration estimate. In some cases, the time estimate is shown after toggling or interacting with the selector 210.

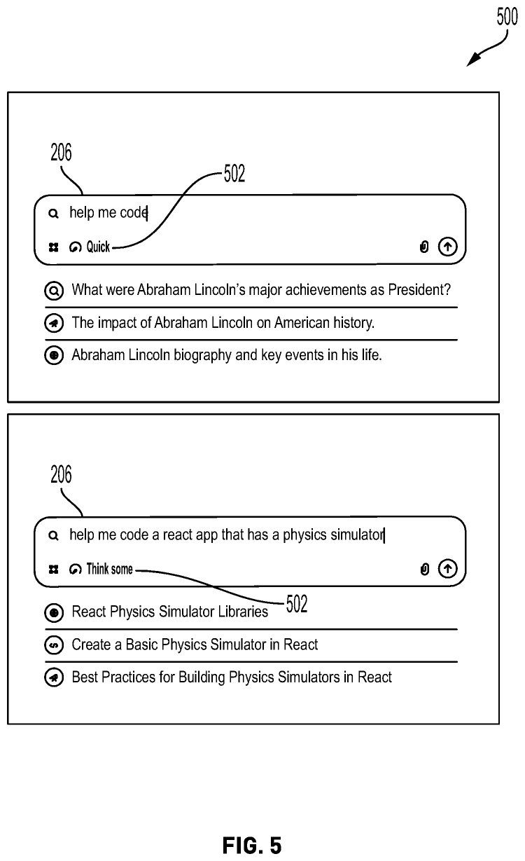

FIG. 5 illustrates an example graphical user interface 500 of an AI assistant service with a compute allocation user interface in accordance with some aspects of the present technology.

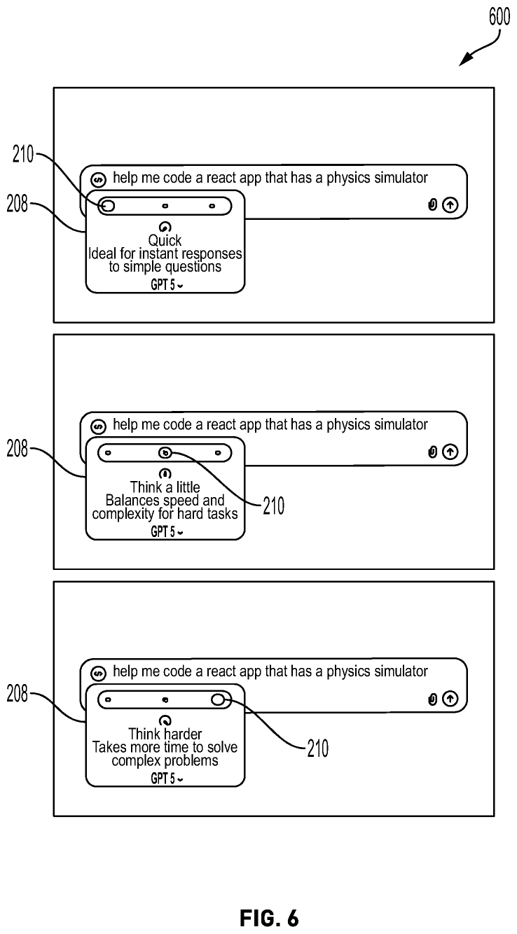

The example prompt composer 206 may include an icon 502 of the compute allocation user interface 208 that previews a selected compute allocation setting and upon selection, may enable users to change the compute allocation setting. In some cases, engaging the icon 502 brings up the compute allocation user interface 208, shown in in FIG. 6.

A user can provide a prompt into prompt composer 602, which is received by the front end. As the user enters the prompt, the prompt composer can send the prompt (word-by-word or character-by-character) to the compute duration prediction model 138. The compute duration prediction model 138 can repeatedly return a prediction word-by-word or character-by-character of a classification of the compute duration. In some embodiments, the classification of the compute duration can be something akin to short, medium, and long. In some embodiments, the computer duration can be an estimated amount of time that the generative response engine will take to return a response, and the front end can interpret those values into updated states as illustrated in FIG. 5.

FIG. 6 illustrates example graphical user interfaces 600 of an AI assistant service with a compute allocation user interface in accordance with some aspects of the present technology.

The example compute allocation user interfaces 208 in FIG. 6 show a different version of the compute allocation user interface 208 with the selector 210 at different compute allocation settings. The compute allocation user interfaces 208 may have been triggered upon engagement of the icon 502. For example, the front end can have received a user input interacting with icon 502. In response to receiving that user input, the front end can respond by displaying the compute allocation user interface 208. The front end can further receive a selection or manipulation of selector 210. The selection 210 is an input that indicates the amount of time the user would like the generative response engine to spend processing the prompt.

In some embodiments, the compute duration prediction model 138 can have previously predicted a version of the generative response engine and an amount of compute time to process the response for the valid positions of the selector. In which case the compute allocation user interface 208 can update using the already received data. Alternatively, in some embodiments, the front end can send information on the position of the selector to the compute duration prediction model 138 and can receive back the predicted version of the generative response engine and the amount of compute time to process the response, and can render the information in the compute allocation user interface 208.

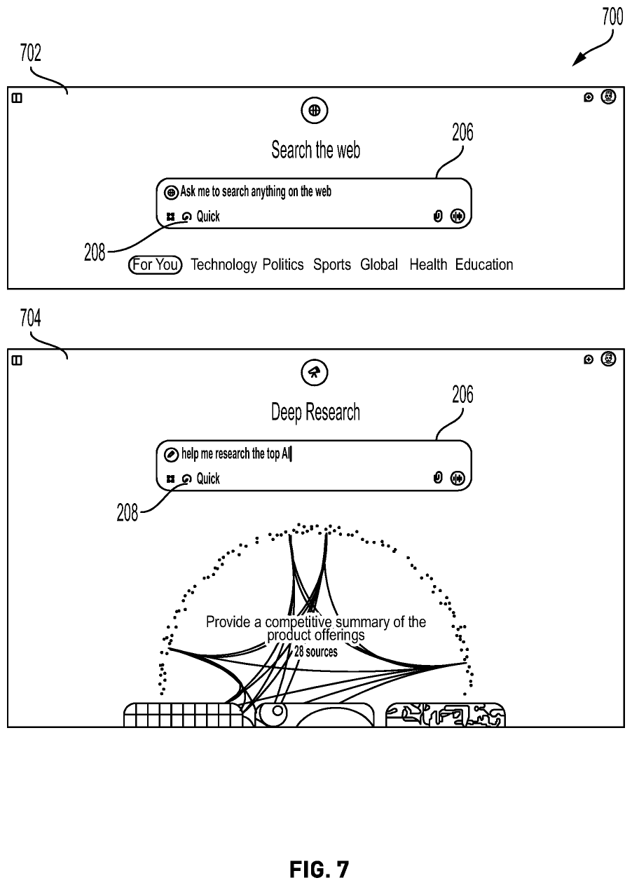

FIG. 7 illustrates example graphical user interfaces 700 with an integrated AI assistant service having a compute allocation user interface in accordance with some aspects of the present technology.

In some cases, as shown in FIG. 7, the AI assistant service may be integrated into other interfaces, such as a search engine interface 702 and a deep research interface 704. By integrating AI assistant service into other interfaces, such as a search engine interface 702 and a deep research interface 704, a more comprehensive and seamless user experience is provided. In some cases, the other interfaces are third-party applications.

The integration of the AI assistant service with a search engine interface 702 allows users to seamlessly switch between searching for information and having a conversational interaction with the AI assistant service. For example, a user may start by typing a search query into the search engine interface 702, but then decide to ask a follow-up question or seek more specific information on the topic. The resulting response may be a mixture of a response and search results. In some cases, when integrated in a search engine, the default compute allocation setting 212 is set to use a lesser compute allocation.

Similarly, integrating the AI assistant service with a deep research interface 704 enables users to have in-depth discussions and debates about complex topics, using the knowledge base and reasoning capabilities of the AI assistant service 100 to provide insightful responses. The integration can be particularly useful for students, researchers, or professionals who need to explore nuanced topics and gain new insights. In some cases, when integrated in a deep research interface 704, the default compute allocation setting 212 is set to use a greater compute allocation. Depending on the integration, certain phrases or sentences may be added to the prompt 124 to calibrate the default compute allocation setting 212.

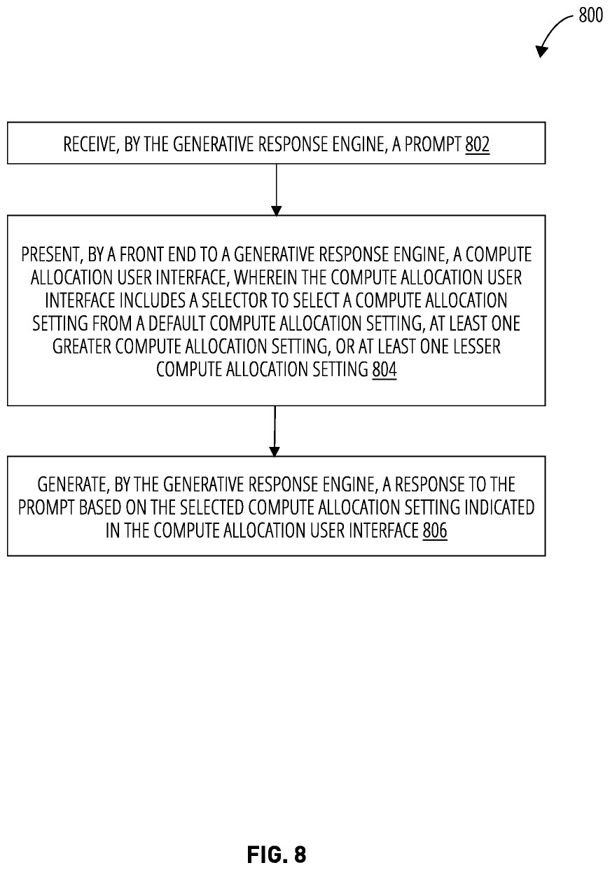

FIG. 8 illustrates an example method 800 for adaptive compute allocation for generative response engines in accordance with some aspects of the present technology. Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the method 800 may perform functions at substantially the same time or in a specific sequence.

According to some examples, the method includes receiving, by the generative response engine, a prompt at step 802. For example, the front end 102 in FIG. 1 can present a prompt composer which may receive the prompt. In some cases, the prompt may include explicit and/or implicit instructions regarding the compute allocation setting. In some cases, the compute duration prediction model 138 determines, from the prompt, an estimated duration for processing the prompt under the default compute allocation setting. In some cases, the compute duration prediction model predicts a version of the generative response engine to be used to generate the response using the default compute allocation setting.

As the user begins typing into the prompt composer, an icon, similar to 502 shown in FIG. 5, may appear. The prompt composer can transmit the evolving prompt—word-by-word or character-by-character—to the compute duration prediction model 138. In real-time, the model can return updated predictions classifying the expected compute duration as “short,” “medium,” or “long,” or as an estimated time in seconds. These predictions can inform visual changes to the interface (as shown in FIG. 5), signaling to the user how demanding the current input is from a compute standpoint. In some embodiments, the compute duration can be an estimated amount of time that the generative response engine will take to return a response, and the front end can interpret those values into updated states as illustrated in FIG. 5.

For example, compute duration prediction model 138 may receive a prompt from the front end, which includes a specific instruction to allocate more computational resources for processing the response. For instance, the prompt reads: “Generate a detailed analysis of climate change impacts on global food systems.” The compute duration prediction model 138 can predict that the response will take ~60 seconds to complete at the default setting.

As shown in FIGS. 5, 6, and 7, the GUI may follow a multi-stage flow. Initially, the user is presented with an empty-state prompt composer (FIG. 7). As a user begins typing, compute predictions may dynamically update in the background. When the user interacts with an icon, similar to 502 shown in FIG. 5, the action may trigger the appearance of the compute allocation interface 208, as described in step 804. The user can then access a selector 210 (such as a slider shown in FIGS. 2-4 and 6), which allows them to manually adjust the compute level—effectively signaling whether they want the model to think “less” or “more” in response to their prompt.

In some embodiments, the compute duration prediction model 138 can also select a version of the generative response engine. For example, by default, a prompt will be send to a fast version of the generative response engine (e.g., a single shot model like ChatGPT 4-o, or a distilled model (a mini model version). As the prompt editor receives inputs providing the prompt, the compute duration prediction model 138 can determine that the prompt should be sent to a different model than the default model. For example, the prompt might be to generate an image or video and therefore the prompt could be directed to a model configured with those capabilities. In another example, the compute duration prediction model 138 could determine that the prompt should be directed to a reasoning model, or to a model that has certain capabilities such as a computer using agent, a deep research model, a mathematical model, an automated software coding model, a model with search capabilities, etc.

According to some examples, the method includes presenting, by a graphical user interface to a generative response engine of an AI assistant service, a compute allocation user interface at step 804. For example, the graphical user interface 104 and/or the front end 102 in FIG. 1 may present the compute allocation user interface. The compute allocation user interface may include a selector to select a compute allocation setting selected from one of at least a default compute allocation setting, a greater compute allocation setting, and lesser compute allocation setting.

The selector allows users to seamlessly adjust the compute allocation for generating a response to the prompt. The compute allocation may range from minimal compute allocation for quick, surface-level responses to greater compute allocation for deeply reasoned, complex analyses.

Upon selecting a compute allocation setting, the AI assistant service 100 may employ a specific model that is optimized for the chosen level of computational resource utilization. The optimization ensures that the selected model can efficiently process the prompt and generate an accurate response within the specified time frame.

In some cases, the model selection may be determined by the compute allocation setting. For instance, quick responses might be handled by a fast single-shot model, which leverages a pre-trained model to provide rapid results without an internal reasoning process. Conversely, complex responses might be handled by a reasoning or deep research model that spends more time processing the prompt and generating an answer.

In some cases, single-shot models are inherently designed such that their internal processing is fixed. Single-shot models provide an answer without reasoning about how to come up with the answer or reviewing the answer to reason about whether the answer might be correct. But, it is possible to limit the length of an output of a single-shot model by adjusting the number of tokens generated. The correlation between tokens generated and response time enables users to tailor their compute allocation settings to achieve the desired level of response detail and speed of response.

Reasoning models, by contrast, can generate a chain-of-thought that can deliberate about how best to respond to a prompt and/or to provide criteria for evaluating a response. The reasoning model will then use the chain-of-thought (or a summary thereof) to guide the reasoning model's generation of the response. Reasoning models can sometimes revise their chain-of-thought or revise its answer. Accordingly, reasoning models can have very long processing times. Even if a reasoning model were limited in the size of its context window or in the length or a requested output, these constraints would not necessarily limit the amount of reasoning the model could perform. Accordingly, the present technology can be used to control the amount of reasoning that a reasoning model might perform.

In some embodiments, the compute allocation user interface might only be displayed when the compute duration prediction model 138 determines that a model other than the default single shot model should be used. For example, if the compute duration prediction model 138 determines that the prompt should go to a default single shot model, then the compute allocation interface might not be shown since there is limited ability to adjust the amount of time it takes to generate the output. But, if the compute duration prediction model 138 determines that the prompt should go to a reasoning model, the front end can be caused to display the compute allocation user interface. The compute allocation user interface might be limited to adjusting the amount of time spent processing a prompt, but might not be able to cause a new model to be selected, or the computer allocation user interface might be used to single that a reasoning model is not needed (by selecting the lowest setting) or that a deep research model is desired (by selecting a highest setting), or that more or less processing is desired from the reasoning model.

Accordingly, the compute duration prediction model 138 can be used to both predict a model to receive the prompt and estimate the necessary processing time. Whether the compute allocation user interface is displayed might be dependent on the model chosen by the compute duration prediction model 138. And the computer allocation user interface might be limited to adjusting processing time within a selected model, or used to give input on which model the user account prefers.

Even amongst models of the same type (single-shot or reasoning models), some models might be specialized for specific tasks. Some models might be better a coding, creative writing, Internet browsing, math problems, financial analysis, etc. Accordingly, the compute duration prediction model 138 can also select the best model to response to the prompt.

As such, the example compute allocation user interface 208 combined with the compute duration prediction model 138 may assist in proactively determining the appropriate reasoning level and a selection of a model, before the user even sends their prompt to the selected model, effectively reducing cognitive load and simplifying the user experience. The selector functionality gives users control over the computational complexity whereby users can adjust the computational complexity predicted by the compute duration prediction model 138 with a simple gesture. In this way, users have a straightforward mechanism for indicating their expectation about how long a model should take to provide a response. The indication, therefore, implies whether the user thinks the problem is complicated, how long of a response they are expecting, and other attributes. These inferences can be used to better deliver a response that matches the user's expectations.

Upon receiving user input moving the selector to the greater compute allocation setting 114 the compute allocation user interface may response showing that the estimated duration for processing the prompt under the default compute allocation setting would be approximately 10-15 minutes. The determination of the revised estimated duration might have been predicted by the compute duration prediction model 138 before the slider was adjusted or after receiving the input that adjusted the slider. The input moving the selector to the greater compute allocation setting 114 can also be associated with a selection of a different model to process the prompt.

In some embodiments, the compute duration prediction model 138 was trained on a dataset of prompts and an amount of time taken to process the prompt. In some examples, the compute duration prediction model 138 also was trained on a dataset of prompts and models that are best used to process the prompts. In this way, the compute duration prediction model 138 can learn to predict response duration times and model selections.

In some cases, the compute allocation user interface may receive an input corresponding to a selection. The input may include movement of the selector along a slider. The input at the compute allocation user interface may be effective to select a greater compute allocation setting or a lesser compute allocation setting may be received. For example, the input may be a selected compute allocation setting of the selector and a sliding movement of the selector to a different location. In some cases, a greater estimated duration or a lesser estimated duration for processing the prompt with the greater compute allocation setting or the lesser compute allocation setting may be presented, respectively. The greater estimated duration or the lessor estimated duration may be generated based on the default estimated duration and the input, respectively.

In some cases, such as when the selector is a slider, as the input changes the selected compute allocation setting from lessor to greater or vice versa, the estimated duration may be recalculated and updated. In some cases, the calculation for greater or lesser estimated durations may be estimated based on the default estimated duration and the input. For example, it may be a simple formula for adding or subtracting time from the default estimated duration based on the input and how far away the slider is from the default compute allocation setting. In other cases, the compute duration prediction model may output based on the model, the greater estimated duration or the lesser estimated duration based on the input. In some cases, the AI assistant service may dynamically update the expected response time in response to a change in selected compute allocation setting.

For example, when interacting with graphical user interface 104 of the AI assistant service 100, users can adjust compute allocation settings through the compute allocation user interface 208. The compute allocation user interface 208 may receive inputs from the user, such as movement of a slider or selection changes, which trigger changes to the compute allocation setting.

Upon receiving the input, the front end 102, which serves as the interface and intermediary between the user and the generative response engine 110 and encompasses the graphical user interface 104 and APIs 106 that facilitate communication, may process the response by sending the prompt to the generative response engine 110. In some cases, the generative response engine 110 also considers other context in which the input was given, considering the user's intent and adapting the output accordingly. For example, if the user selects a greater compute allocation setting and/or the compute allocation user interface 208 is integrated in a deep research interface, the generative response engine 110 may generate a more detailed or elaborate response, while a lesser setting or integration with a search engine may result in a shorter or more concise answer.

One common misconception about AI is that it is all-knowing and always right. However, in reality, AI systems are designed to provide insights and recommendations based on their training data, but they are not omniscient. Human oversight and interaction are essential for refining these models and ensuring that they meet the needs of diverse users.

By incorporating user interface mechanisms for adjusting compute allocation settings, the system recognizes that context matters when it comes to AI effectiveness. The ability of an AI system to understand and adapt to user needs depends on its ability to learn from interactions and feedback. In other words, AI is not a static entity that can provide all answers; rather, it is a dynamic tool that requires collaboration and co-design with humans.

Furthermore, the present invention addresses another misconception about AI: that users will always be satisfied with the output generated by a system. However, this is often not the case. Users may have varying needs and preferences for response quality, format, or tone, which can only be met through human intervention and feedback. By providing users with control over compute allocation settings, the AI assistant service 100 acknowledges these complexities and recognizes that AI should be used as a tool to support human decision-making, rather than being expected to provide all answers.

Furthermore, the compute allocation settings are fundamentally relative and context-dependent, recognizing that computational complexity varies dramatically across different prompts. In one scenario, a default compute allocation setting might require 8 minutes of processing for a complex query about advanced scientific concepts, while the same default compute allocation setting could resolve a simple factual question in just 1 minute. This dynamic approach means that the computational time scales are inherently adaptive, with greater estimated durations and lessor estimated durations being proportionally adjusted based on the specific prompt's intrinsic complexity.

For instance, if the first prompt in a session requires 10 minutes of computational processing, and the subsequent prompt demands significantly less complexity, the UI would reflect this change, providing users with transparent, prompt-specific time estimates. This approach transforms the compute-allocation interface from a generic setting into an intelligent, adaptive system that provides users with precise, context-aware computational investment predictions.

According to some examples, the method includes generating, by the generative response engine, a response to the prompt using the compute allocation indicated in the compute allocation user interface at step 806. For example, the generative response engine 110 in FIG. 1 may generate the response. In some embodiments, the front end can send details about the user's input to the generative response engine to cause the generating response engine to generate the response to the prompt using the compute allocation indicated in the compute allocation user interface. For example, the front end could convert the slider settings or estimated time for processing into words (tokens) that the generative response engine can use to determine how long it should spend generating the response. In another example, the front end could send the slider settings (default, think less, think more) to the generative response engine. In another example, the front end could send a number of tokens that the generative response engine should use to generate the response, where the number of tokens is correlated to the predicted amount of time presented in the compute allocation user interface.

As addressed above, in some examples, the compute duration prediction model 138 might also select the appropriate version of the generative response engine to process the prompt. In such embodiments, the front end uses the determination provided by the computer duration predication model 138 to determine which version of the generative response engine to send the prompt to. For example, if the computer duration prediction model 138 has determined that the response should be processed by the reasoning model, the front end will send the prompt to the reasoning model by calling an internal API used to interact with the reasoning model. In this way, prompts can be routed to the models that are appropriate for responding to the prompt without the user needing to have knowledge of the attributes of the various models. This can result in efficiency for the generative response service 100 too, by routing prompts to the models that can efficiently provide a satisfactory response. This can prevent the overuse of models that are associated with greater resource consumption from being used for response where a more efficient model will suffice.

In some cases, a user may have a follow up question or comment in a next prompt in a same conversation thread. In some cases, the selected model may be maintained throughout the conversation thread. That way, the user does not need to reselect the same selected compute allocation setting. However, in some cases, an adjustment from the selected compute allocation setting may be determined based on the next prompt. For example, if the first prompt asked a sophisticated question and a greater compute allocation setting was selected, if the second prompt is merely a factual question that is a follow up, there may not be a need for the greater compute allocation setting. Although it is possible to switch models after a first prompt, the benefit of switching models should be compelling. One of the largest drivers of latency for the generative response engine comes in tokening the prompt and allocating them to memory of a particular GPU. Therefore, once a conversation has been tokenized and loaded into memory, further turns in the conversation are much more likely to go to the same model.

In some cases, the compute duration prediction model 138 may be especially trained to predict the computational resources required to generate high-quality responses. By selecting the optimal capacity for the model, the system can ensure that it has enough resources to produce accurate and relevant responses. Once the capacity of the model is determined, the greater or lesser allocation setting can be applied to adjust the token allocation accordingly. This allows the system to fine-tune the response generation process based on the predicted compute time, rather than selecting an arbitrary allocation setting.

By having the compute duration prediction model select the capacity of the model first, and then applying the allocation settings second, the system can ensure that it is using the most efficient resources possible to generate high-quality responses. This approach also allows for more accurate predictions of the compute time required for different response lengths and complexities.

According to some examples, the method includes selecting a model with an optimal capacity based on the compute time required. For example, the compute duration prediction model 138 and/or the generative response engine 110 in FIG. 1 may select the model. In some cases, the selected model is a version of the generative response engine 110.

According to some examples, the method includes determining a default token allocation settings based on the selected model. For example, the compute duration prediction model 138 and/or the generative response engine 110 in FIG. 1 may determine the default token allocation settings. The compute duration prediction model 138 estimates the duration required to generate a response to a prompt based on various factors, such as the complexity of the prompt, the user's previous behavior, and the available computational resources. Based on this estimated duration, the compute duration prediction model 138 predicts which version of the generative response engine 110 is likely to be most suitable for generating the response. Different versions may have different compute allocation requirements, with some requiring more or fewer computational resources than others.

The predicted version is then used to determine the default compute allocation setting. This setting may be a fixed value, or it may be dynamically adjusted based on various factors, such as the user's current resource usage or the overall system load.

According to some examples, the method includes applying the greater compute allocation setting or lesser compute allocation setting to the default token allocation settings to adjust an applied token allocation. For example, the compute duration prediction model 138 and/or the generative response engine 110 in FIG. 1 may apply the greater compute allocation setting or lesser compute allocation setting to the default token allocation settings to adjust the applied token allocation.

When a user selects a greater compute allocation setting, the generative response engine may justify the additional time spent by refining, verifying, and polishing the response to ensure depth and coherence. This means that instead of merely taking longer, the generative response engine may actively work to enhance the quality of the response by performing deeper reasoning, structuring information more effectively, and self-correcting inconsistencies. In some cases, the compute allocation user interface may present an indication of how time is allocated differently depending on the selected compute allocation setting. If the user chooses a greater compute allocation setting, an indication may be given that additional time beyond the default estimated duration is being used for refinement, self-correction, and deeper analysis. In some cases, a navigable reasoning path based on the refinement by the generative response engine may be presented.

The navigable reasoning path may be a structured, transparent framework that allows users to follow the generative response engine reasoning process step by step. This path ensures that each part of the response is clearly linked to the underlying reasoning, allowing the user to understand how the model arrived at its conclusions. For example, in a scientific explanation, such as a description of quantum entanglement, the reasoning path might include an initial definition, followed by a breakdown of the underlying principles, historical experiments, and real-world applications. If the model deems necessary, it might ask follow-up questions to clarify ambiguous points or refine its understanding, with each of these steps also made available for the user to navigate through. Similarly, when optimizing a sorting algorithm, the reasoning path could involve the model comparing various algorithms, analyzing trade-offs, and suggesting the best solution, while also providing options to view different stages of its analysis.

This approach allows users to see how the generative response engine double-checks its work and refines its responses. If the generative response engine detects inconsistencies or areas of improvement, it can automatically go back, re-evaluate its conclusions, and refine its reasoning. For instance, if a generative response engine generates a business strategy for a tech startup, the reasoning path could reveal how the generative response engine explores different market trends, generates potential strategies, and revises them based on further consideration. The refinement process becomes part of the user's experience, where each revision or clarification is a step the user can access.

When a user selects a lesser compute allocation setting, rather than simply generating a rushed response, the generative response engine may prioritize efficiency by focusing on directness, conciseness, and decisiveness. Instead of over-explaining or exploring multiple possibilities, it streamlines its thought process, delivering the most probable correct answer in a straightforward manner. By reducing verbosity and avoiding unnecessary refinements, the generative response engine ensures that the lesser compute allocation setting does not equate to lower quality but rather an optimized response that remains accurate and meaningful.

Conversely, when a user opts for a lesser compute allocation setting, the system may indicate that the response is being condensed further than usual, favoring brevity and directness while ensuring key information remains intact. For example, if a user requests a complex business strategy breakdown, selecting greater compute could trigger a message like, “This response took additional time for refinement and verification.” If the same query is set to lesser compute, an indication could state, “This response was optimized for speed with a more condensed summary.”

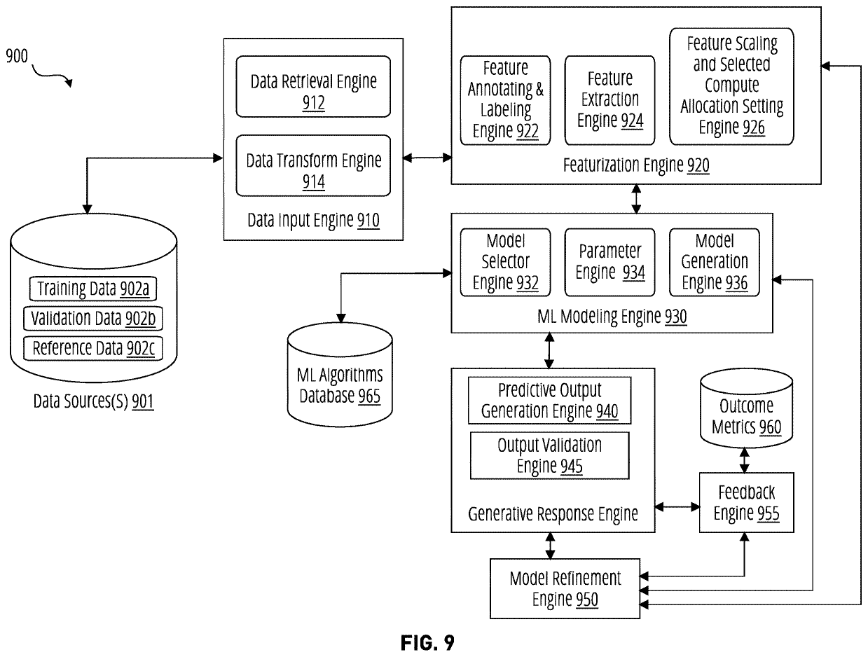

FIG. 9 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 900 may include data input engine 910 that can further include data retrieval engine 912 and data transform engine 914. Data retrieval engine 912 may be configured to access, interpret, request, or receive data, which may be adjusted, reformatted, or changed (e.g., to be interpretable by another engine, such as data input engine 910). For example, data retrieval engine 912 may request data from a remote source using an API. Data input engine 910 may be configured to access, interpret, request, format, re-format, or receive input data from data sources(s) 901. For example, data input engine 910 may be configured to use data transform engine 914 to execute a re-configuration or other change to data, such as a data dimension reduction. In some aspects, data sources(s) 901 may be associated with a single entity (e.g., organization) or with multiple entities. Data sources(s) 901 may include one or more of training data 902a (e.g., input data to feed a machine learning model as part of one or more training processes), validation data 902b (e.g., data against which at least one processor may compare model output with, such as to determine model output quality), and/or reference data 902c. In some aspects, data input engine 910 can be implemented using at least one computing device. For example, data from data sources(s) 901 can be obtained through one or more I/O devices and/or network interfaces. Further, the data may be stored (e.g., during execution of one or more operations) in a suitable storage or system memory. Data input engine 910 may also be configured to interact with a data storage, which may be implemented on a computing device that stores data in storage or system memory.

System 900 may include featurization engine 920. Featurization engine 920 may include feature annotating & labeling engine 922 (e.g., configured to annotate or label features from a model or data, which may be extracted by feature extraction engine 924), feature extraction engine 924 (e.g., configured to extract one or more features from a model or data), and/or feature scaling and selected compute allocation setting engine 926. Feature scaling and selected compute allocation setting engine 926 may be configured to determine, select, limit, constrain, concatenate, or define features (e.g., AI features) for use with AI models.

System 900 may also include machine learning (ML) ML modeling engine 930, which may be configured to execute one or more operations on a machine learning model (e.g., model training, model re-configuration, model validation, model testing), such as those described in the processes described herein. For example, ML modeling engine 930 may execute an operation to train a machine learning model, such as adding, removing, or modifying a model parameter. Training of a machine learning model may be supervised, semi-supervised, or unsupervised. In some aspects, training of a machine learning model may include multiple epochs, or passes of data (e.g., training data 902a) through a machine learning model process (e.g., a training process). In some aspects, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed aspects in any way, a machine learning model may include millions, billions, or even trillions of model parameters. ML modeling engine 930 may include model selector engine 932 (e.g., configured to select a model from among a plurality of models, such as based on input data), parameter engine 934 (e.g., configured to add, remove, and/or change one or more parameters of a model), and/or model generation engine 936 (e.g., configured to generate one or more machine learning models, such as according to model input data, model output data, comparison data, and/or validation data).

In some aspects, model selector engine 932 may be configured to receive input and/or transmit output to ML algorithms database 965. Similarly, featurization engine 920 can utilize storage or system memory for storing data and can utilize one or more I/O devices or network interfaces for transmitting or receiving data. ML algorithms database 965 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein.

System 900 can further include generative response engine 110 that is made up of a predictive output generation engine 940, output validation engine 945 (e.g., configured to apply validation data to machine learning model output). Predictive output generation engine 940 can be configured to receive inputs that provide some guidance as to a desired output. Predictive output generation engine 940 can analyze the input and identify relevant patterns and associations in the data it has learned to generate a sequence of words that predictive output generation engine 940 predicts is the most likely continuation of the input, aiming to provide a coherent and contextually relevant answer. Predictive output generation engine 940 generates responses by sampling from the probability distribution of possible words and sequences, guided by the patterns observed during its training. In some aspects, predictive output generation engine 940 can generate multiple possible responses before presenting the final one. Predictive output generation engine 940 can generate multiple responses based on the input, and these responses are variations that predictive output generation engine 940 considers potentially relevant and coherent. Output validation engine 945 can evaluate these generated responses based on certain criteria. These criteria can include relevance to the prompt, coherence, fluency, and sometimes adherence to specific guidelines or rules, depending on the application. Based on this evaluation, output validation engine 945 selects the most appropriate response. This selection is typically the one that scores highest on the set criteria, balancing factors like relevance, informativeness, and coherence.

System 900 can further include feedback engine 955 (e.g., configured to apply feedback from a user and/or machine to a model) and model refinement engine 950 (e.g., configured to update or re-configure a model). In some aspects, feedback engine 955 may receive input and/or transmit output (e.g., output from a trained, partially trained, or untrained model) to outcome metrics database 960. Outcome metrics database 960 may be configured to store output from one or more models and may also be configured to associate output with one or more models. In some aspects, outcome metrics database 960, or other device (e.g., model refinement engine 950 or feedback engine 955), may be configured to correlate output, detect trends in output data, and/or infer a change to input or model parameters to cause a particular model output or type of model output. In some aspects, model refinement engine 950 may receive output from predictive output generation engine 940 or output validation from model refinement engine 950. In some aspects, model refinement engine 950 may transmit the received output to featurization engine 920 or ML modeling engine 930 in one or more iterative cycles.

The engines of system 900 may be packaged functional hardware units designed for use with other components or a part of a program that performs a particular function (e.g., of related functions). Any or each of these modules may be implemented using a computing device. In some aspects, the functionality of system 900 may be split across multiple computing devices to allow for distributed processing of the data, which may improve output speed and reduce computational load on individual devices. In some aspects, system 900 may use load-balancing to maintain stable resource load (e.g., processing load, memory load, or bandwidth load) across multiple computing devices and to reduce the risk of a computing device or connection becoming overloaded. In these or other aspects, the different components may communicate over one or more I/O devices and/or network interfaces.

System 900 can be related to different domains or fields of use. Descriptions of aspects related to specific domains, such as natural language processing or language modeling, is not intended to limit the disclosed aspects to those specific domains, and aspects consistent with the present disclosure can apply to any domain that utilizes predictive modeling based on available data.

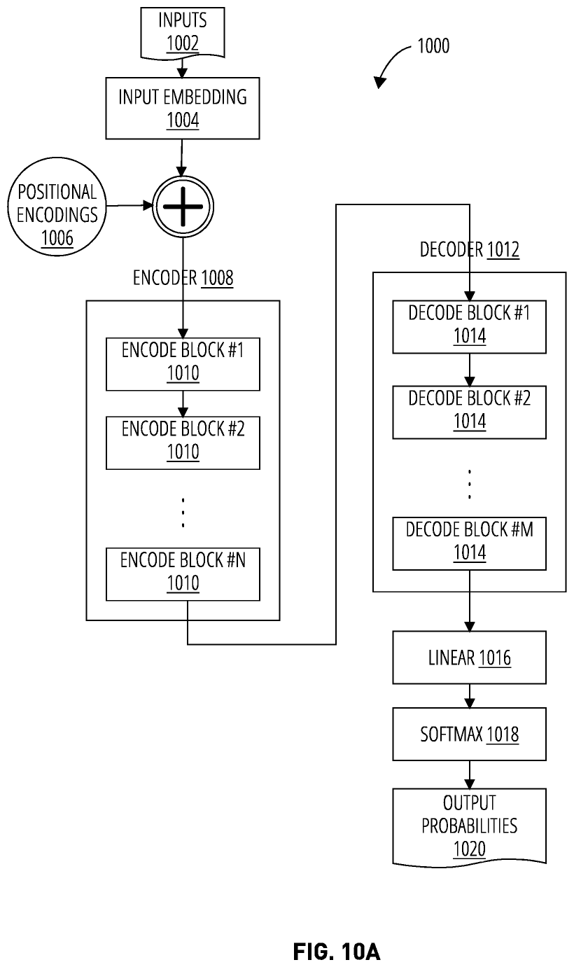

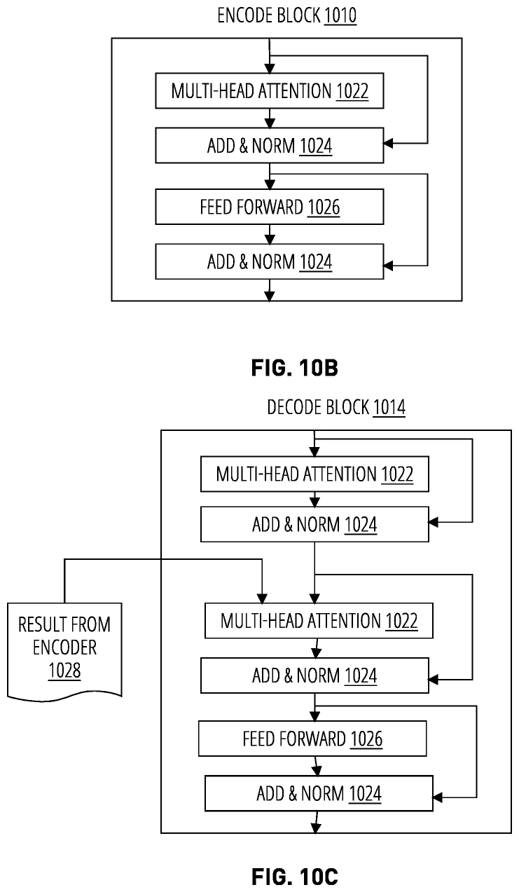

FIG. 10A, FIG. 10B, and FIG. 10C illustrates an example transformer architecture in accordance with some aspects of the present technology. Examples of ML models that use a transformer neural network (e.g., transformer architecture 1000) can include, e.g., generative pretrained transformer (GPT) models and Bidirectional Encoder Representations from Transformer (BERT) models. The transformer architecture 1000, which is illustrated in FIG. 10A, FIG. 10B, and FIG. 10C, includes inputs 1002, input embedding block 1004, positional encodings 1006, encoder 1008 including encode blocks, such as encode block 1010, decoder 1012 including decode block 1014, linear block 1016, softmax block 1018, and output probabilities 1020.

Input embedding block 1004 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 1004 can be learned embeddings to convert the input tokens and output tokens to vectors of dimension that have the same dimension as the positional encodings, for example.

Positional encodings 1006 provide information about the relative or absolute position of the tokens in the sequence. According to certain non-limiting examples, positional encodings 1006 can be provided by adding positional encodings to the input embeddings at the inputs to the encoder 1008 and decoder 1012. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 1008 can use stacked self-attention and point-wise, fully connected layers. Encoder 1008 can be a stack of N identical layers (e.g., N=6), and each layer can be an encode block, as illustrated by encode block 1010 shown in FIG. 10B. Each encode block 1010 has two sub-layers: (i) a first sub-layer has a multi-head attention block 1022 and (ii) a second sub-layer has a feed forward block 1026, which can be a position-wise fully connected feed-forward network. The feed forward block 1026 can use a rectified linear unit (ReLU).

Encoder 1008 uses a residual connection around each of the two sub-layers, followed by an add & norm block 1024, which performs normalization. For example, the output of each sub-layer can be LayerNorm(x+Sublayer(x)). To facilitate these residual connections, all sub layers in the model, as well as the embedding layers, produce output data having a same dimension.

Similar to encoder 1008, decoder 1012 uses stacked self-attention and point-wise, fully connected layers. Decoder 1012 can also be a stack of M identical layers (e.g., M=6), and each layer can be a decode block, as illustrated by decoder 1012 shown in FIG. 10B. In addition to the two sub-layers (i.e., the sublayer with multi-head attention block 1022 and the sub-layer with feed forward block 1026) found in encode block 1010, decode block 1014 can include a third sub-layer, which performs multi-head attention over the output of the encoder stack 1028. Similar to encoder 1008, decoder 1012 uses residual connections around each of the sub-layers, followed by layer normalization. Additionally, the sub-layer with multi-head attention block 1022 can be modified in the decoder stack to prevent positions from attending to subsequent positions. This masking, combined with the fact that the output embeddings are offset by one position, can ensure that the predictions for position i can depend only on the known output data at positions less than i.

Linear block 1016 can be a learned linear transformation. For example, when transformer architecture 1000 is being used to translate from a first language into a second language, linear block 1016 can project the output from the last decode softmax block 1018 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 1018 then turns the scores from linear block 1016 into output probabilities 1020 (which add up to 1.0). In each position, the index provides for the word with the highest probability, and then maps that index to the corresponding word in the vocabulary. Those words then form the output sequence of transformer architecture 1000. The softmax operation is applied to the output from linear block 1016 to convert the raw numbers into output probabilities 1020 (e.g., token probabilities).

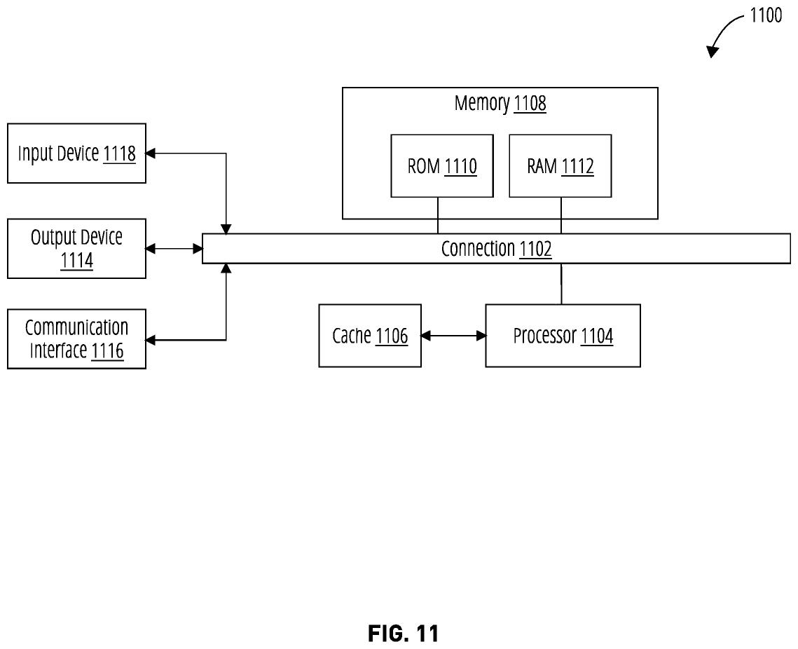

FIG. 11 shows an example of computing system 1100 in accordance with some aspects of the present technology, which can be, for example, any computing device making up any engine illustrated in FIG. 1 and FIG. 2 or any component thereof.

In some aspects, computing system 1100 is a single device, or a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

In some aspects, computing system 1100 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 1100 includes at least one processing unit (CPU or processor) 1104 and connection 1102 that couples various system components including system memory 1108, such as read-only memory (ROM) 1110 and random access memory (RAM) 1112 to processor 1104. Memory 1108 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 1108 can include software services, servers, logic, etc., that when the code that defines such software is executed by the processor 1104, it causes the system to perform a function. In some aspects, a hardware service that performs a particular function can include the software component stored in a computer-readable medium in connection with the necessary hardware components, such as processor 1104, connection 1102, output device 1114, etc., to carry out the function.

Computing system 1100 can include a cache of high-speed memory 1106 connected directly with, in close proximity to, or integrated as part of processor 1104.

Connection 1102 can be a physical connection via a bus, or a direct connection into processor 1104, such as in a chipset architecture. Connection 1102 can also be a virtual connection, networked connection, or logical connection.

Processor 1104 can include any general purpose processor and a hardware service or software service stored in memory 1108, configured to control processor 1104 as well as a special-purpose processor where software instructions are incorporated into the actual processor design. Processor 1104 may essentially be a completely self-contained computing system, containing multiple cores or processors, a bus, memory controller, cache, etc. A multi core processor may be symmetric or asymmetric. Processor 1104 can be physical or virtual.

To enable user interaction, computing system 1100 includes an input device 1118, which can represent any number of input mechanisms, such as a microphone for speech, a touch-sensitive screen for gesture or graphical input, keyboard, mouse, motion input, speech, etc. Computing system 1100 can also include output device 1114, which can be one or more of a number of output mechanisms known to those of skill in the art. In some instances, multimodal systems can enable a user to provide multiple types of input/output to communicate with computing system 1100. Computing system 1100 can include communication interface 1116, which can generally govern and manage the user input and system output. There is no restriction on operating on any particular hardware arrangement, and therefore the basic features here may easily be substituted for improved hardware or firmware arrangements as they are developed.

In some aspects, computing system 1100 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or methods in a method embodied in software, or combinations of hardware and software.

Any of the steps, operations, functions, or processes described herein may be performed or implemented by a combination of hardware and software services or services, alone or in combination with other devices. In some aspects, a service can be software that resides in memory of a client device and/or one or more servers of the AI assistant service and perform one or more functions when a processor executes the software associated with the service. In some aspects, a service is a program or a collection of programs that carry out a specific function. In some aspects, a service can be considered a server. The memory can be a non-transitory computer-readable medium.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects

The present technology includes computer-readable storage mediums for storing instructions, and systems for executing any one of the methods embodied in the instructions addressed in the aspects of the present technology presented below:

Aspect 1: A computer-implemented method for adaptive compute allocation for generative response engines, comprising: presenting, by a front end to a generative response engine, a compute allocation user interface, wherein the compute allocation user interface includes a selector to select a compute allocation setting from a default compute allocation setting, at least one greater compute allocation setting, or at least one lesser compute allocation setting; receiving, by the generative response engine, a prompt; and generating, by the generative response engine, a response to the prompt based on the selected compute allocation setting indicated in the compute allocation user interface.

Aspect 2: The computer-implemented method of aspects 1, further comprising: determining, based on the prompt, a default estimated duration for processing the prompt under the default compute allocation setting by the generative response engine.

Aspect 3: The computer-implemented method of any one of aspects 1-2, wherein the determining the default estimated duration is performed by a compute duration prediction model trained to provide the default estimated duration for processing the prompt.

Aspect 4: The computer-implemented method of any one of aspects 1-3, wherein the compute duration prediction model predicts a version of the generative response engine to be used to generate the response using the default compute allocation setting.

Aspect 5: The computer-implemented method of any one of aspects 1-4, wherein the compute duration prediction model is configured to prefer a more efficient model until a prediction that the prompt should be directed to a more capable model.

Aspect 6: The computer-implemented method of any one of aspects 1-5, wherein the compute duration prediction model selects a version of the generative response engine automatically based on the prompt.

Aspect 7: The computer-implemented method of any one of aspects 1-6, further comprising: receiving an input at the compute allocation user interface that is effective to select one of the at least one greater compute allocation setting or one of the at least one lesser compute allocation setting; and presenting a greater estimated duration or a lessor estimated duration for processing the prompt with the selected greater compute allocation setting or the selected lesser compute allocation setting, wherein the greater estimated duration or the lessor estimated duration is generated, respectively, based on the default estimated duration and the input.

Aspect 8: The computer-implemented method of any one of aspects 1-7, wherein the greater estimated duration or the lessor estimated duration is generated by the compute duration prediction model.

Aspect 9: The computer-implemented method of any one of aspects 1-8, wherein the selected greater compute allocation setting is selected, further comprising: determining the selected greater compute allocation setting already aligns with the default compute allocation setting; and presenting an indication of spending time additional to the default estimated duration for refinement.

Aspect 10: The computer-implemented method of any one of aspects 1-9, wherein the refinement includes the generative response engine asking additional questions and further refining the response based on responses to the additional questions, the computer-implemented method further comprising: presenting a navigable reasoning bath by the generative response engine based on the refinement.

Aspect 11: The computer-implemented method of any one of aspects 1-10, wherein the selected lesser compute allocation setting is selected, further comprising: determining the selected lesser compute allocation setting already aligns with the default compute allocation setting; and presenting an indication of additional condensing of the response.

Aspect 12: The computer-implemented method of any one of aspects 1-11, further comprising: maintaining the selected compute allocation setting of the compute allocation throughout a conversation thread of the prompt.

Aspect 13: The computer-implemented method of any one of aspects 1-12, further comprising: determining an adjustment from the selected compute allocation setting based on a next prompt in the conversation thread; and generating, by the generative response engine, a next output responsive to the next prompt and executed in alignment with the adjustment in the conversation thread.

Aspect 14: The computer-implemented method of any one of aspects 1-13, wherein the determining the default estimated duration is performed by a compute duration prediction model trained to provide the default estimated duration for processing the prompt, and wherein the adjustment is used as feedback to train the compute duration prediction model to update a set of predefined weights.

Aspect 15: The computer-implemented method of any one of aspects 1-14, further comprising: sending data descriptive of the compute allocation setting to a load balancer of a data center, wherein the load balancer can use the data in making load balancing determinations.

1. A computer-implemented method comprising:
presenting, by a front end to a generative response engine, a prompt composer interface with an indicator for a compute allocation user interface that previews two or more selectable compute allocation settings that affect a generation of a response by the generative response engine;
upon selecting of the indicator, presenting the compute allocation user interface in the prompt composer interface wherein the compute allocation user interface includes a selector object that is configured to be manipulated by a pointer device to indicate a compute allocation setting selected from the two or more selectable compute allocation settings that include a default compute allocation setting, at least one greater compute allocation setting, or at least one lesser compute allocation setting;
receiving, from a user account and by the front end to the generative response engine, a prompt and a selection of the compute allocation setting in the compute allocation user interface, wherein the compute allocation setting controls a relative amount of tokens that the generative response engine can generate when generating the response to the prompt;
receiving, by the generative response engine, the prompt and the compute allocation setting associated with the selection of the compute allocation setting; and
generating, by the generative response engine, the response to the prompt based on the compute allocation setting indicated by the selection of the compute allocation setting in the compute allocation user interface, wherein the at least one greater compute allocation setting causes the generative response engine to use more tokens than the default compute allocation setting when generating the response to the prompt and the at least one lesser compute allocation setting causes the generative response engine to use less tokens than the default compute allocation setting when generating the response to the prompt.

2. The computer-implemented method of claim 1, further comprising:
determining, based on the prompt, a default estimated duration for processing the prompt under the default compute allocation setting by the generative response engine; and
presenting the default estimated duration for processing the prompt in the compute allocation user interface.

3. The computer-implemented method of claim 2, wherein the determining the default estimated duration is performed by a compute duration prediction model trained to provide the default estimated duration for processing the prompt.

4. The computer-implemented method of claim 3, wherein the compute duration prediction model predicts a version of the generative response engine to be used to generate the response using the default compute allocation setting, wherein versions of the generative response engine are generative transformer models.

5. The computer-implemented method of claim 4, wherein the compute duration prediction model is configured to prefer a more efficient model until a prediction that the prompt should be directed to a more capable model.

6. The computer-implemented method of claim 4, wherein the compute duration prediction model selects a version of the generative response engine automatically based on the prompt.

7. The computer-implemented method of claim 3, further comprising:
presenting a greater estimated duration or a lesser estimated duration for processing the prompt with the selected greater compute allocation setting or the selected lesser compute allocation setting, respectively, relative to the default estimated duration.

8. The computer-implemented method of claim 7, wherein the greater estimated duration or the lesser estimated duration is generated by the compute duration prediction model.

9-11. (canceled)

12. The computer-implemented method of claim 1, further comprising:
maintaining the selection of the compute allocation setting throughout a conversation thread of the prompt.

13. The computer-implemented method of claim 2, further comprising:
determining an adjustment from the selection of the compute allocation setting based on a next prompt in a conversation thread; and
generating, by the generative response engine, a next output responsive to the next prompt and executed in alignment with the adjustment in the conversation thread.

14. The computer-implemented method of claim 13, wherein the determining the default estimated duration is performed by a compute duration prediction model trained to provide the default estimated duration for processing the prompt, and wherein the adjustment is used as feedback to train the compute duration prediction model to update a set of predefined weights.

15. The computer-implemented method of claim 1, further comprising:
sending data descriptive of the compute allocation setting to a load balancer of a data center, wherein the load balancer can use the data in making load balancing determinations.

16. A computing device comprising:
one or more processors; and
memory storing instructions that, when executed by the one or more processors, configure the computing device to:
present, by a front end to a generative response engine, a prompt composer interface with an indicator for a compute allocation user interface that previews two or more selectable compute allocation settings that affect a generation of a response by the generative response engine;
upon selecting of the indicator, present the compute allocation user interface in the prompt composer interface, wherein the compute allocation user interface includes a selector object that is configured to be manipulated by a pointer device to indicate a compute allocation setting selected from the two or more selectable compute allocation settings that include a default compute allocation setting, at least one greater compute allocation setting, or at least one lesser compute allocation setting;
receive, from a user account and by the front end to the generative response engine, a prompt and a selection of the compute allocation setting in the compute allocation user interface, wherein the compute allocation setting controls a relative amount of tokens that the generative response engine can generate when generating the response to the prompt;
receive, by the generative response engine, the prompt and the compute allocation setting associated with the selection of the compute allocation setting; and
generate, by the generative response engine, the response to the prompt based on the compute allocation setting indicated by the selection of the compute allocation setting in the compute allocation user interface.

17. The computing device of claim 16, wherein the instructions further configure the computing device to:
determine, based on the prompt, a default estimated duration for processing the prompt under the default compute allocation setting by the generative response engine; and
present the default estimated duration for processing the prompt in the compute allocation user interface.

18. The computing device of claim 17, wherein the determining the default estimated duration is performed by a compute duration prediction model trained to provide the default estimated duration for processing the prompt.

19. The computing device of claim 18, wherein the compute duration prediction model predicts a version of the generative response engine to be used to generate the response using the default compute allocation setting, wherein versions of the generative response engine are generative transformer models.

20-21. (canceled)

22. A non-transitory computer-readable storage medium comprising instructions that when executed by a computer, cause the computer to:
presenting, by a front end to a generative response engine, a prompt composer interface with an indicator for a compute allocation user interface that previews two or more selectable compute allocation settings that affect a generation of a response by the generative response engine;
upon selecting of the indicator, presenting the compute allocation user interface in the prompt composer interface, wherein the compute allocation user interface includes a selector object that is configured to be manipulated by a pointer device to indicate a compute allocation setting selected from the two or more selectable compute allocation settings that include a default compute allocation setting, at least one greater compute allocation setting, or at least one lesser compute allocation setting;
receive, from a user account and by the front end to the generative response engine, a prompt and a selection of the compute allocation setting in the compute allocation user interface, wherein the compute allocation setting controls a relative amount of tokens that the generative response engine can generate when generating the response to the prompt;
receive, by the generative response engine, the prompt and the compute allocation setting associated with the selection of the compute allocation setting; and
generate, by the generative response engine, the response to the prompt based on the compute allocation setting indicated by the selection of the compute allocation setting in the compute allocation user interface.

23. The computer-implemented method of claim 1, wherein the compute allocation setting of the generative response engine is a maximum token budget to be used in generating the response to the prompt.

24. The computer-implemented method of claim 1, wherein the compute allocation setting of the generative response engine is an amount of time the generative response engine can spend reasoning before providing the response to the prompt.

25. (canceled)

26. The computer-implemented method of claim 1, wherein the tokens generated by the generative response engine when generating the response to the prompt includes the tokens generated during reasoning performed by the generative response engine.

27. The computer-implemented method of claim 1, wherein presenting the compute allocation user interface in the prompt composer interface includes:
presenting the compute allocation user interface as part of the prompt composer interface in a drop-down menu or a pop-up window.
